(19) United States
(12) Patent Application Publication
(10) Pub. No.: US 2020/0047010 A1
(43) Pub. Date: Feb. 13, 2020

(54) FIREFIGHTING AIRCRAFT

(71) Applicant: DAESHIN IVE Co., Ltd., Busan (KR)

(72) Inventor: GILL DO LEE, Busan (KR)

(21) Appl. No.: 16/537,512

(22) Filed: Aug. 9, 2019

(30) Foreign Application Priority Data
Aug. 10, 2018 (KR) 10-2018-0093442

(51) Int. Cl. A62C 3/02; B64C 39/02; F41F 1/00

(52) U.S. Cl. CPC A62C 3/025; F41F 1/00; B64C 39/02

(57) ABSTRACT

A firefighting aircraft with a body and wings comprises a firing means configured to fire at least one fire suppression container provided in the body. The at least one fire suppression container has a casing filled with a fire extinguishing material and formed of a material destroyed by an impact. The first extinguishing material includes at least one of a fire extinguishing liquid, a fire extinguishing powder, or a fire extinguishing foam.

### CROSS-REFERENCE TO RELATED APPLICATION(S)

This application is based on and claims priority under 35 U.S.C. 119 to Korean Patent Application No. 10-2018-0093442, filed on Aug. 10, 2018, in the Korean Intellectual Property Office, the disclosure of which is herein incorporated by reference in its entirety.

### TECHNICAL FIELD

Embodiments of the disclosure relate to a firefighting aircraft and, more specifically, to a firefighting aircraft with a structure enabling more effective fire suppression.

### DESCRIPTION OF RELATED ART

For effective suppression of wildfires, firefighting aircraft are used instead of fire trucks which may not enter the site.

A firefighting aircraft includes a body, wings, and a large water tank under the body. The water tank has an opening which is open or closed by a door. While flying over the fire, the firefighting aircraft opens the opening and drops a great quantity of water through the opening, thereby suppressing the fire.

Conventional firefighting aircraft drop water only a single time and need return for refilling water. This may deteriorate the fire suppression efforts.

Thus, a need exists for a method of addressing such issues.

### SUMMARY

According to an embodiment, a firefighting aircraft with a body and wings comprises a firing means configured to fire at least one fire suppression container provided in the body. The at least one fire suppression container having a casing filled with a fire extinguishing material and formed of a material destroyed by an impact. The first extinguishing material includes at least one of a fire extinguishing liquid, a fire extinguishing powder, or a fire extinguishing foam.

The firing means may include a firing pipe having an open front end and oriented to an outside of the body, a feeder connected to a rear end of the firing pipe to supply the at least one fire suppression container to an inside of the firing pipe, and an air feeder configured to supply a high-pressure of air to the inside of the firing pipe to fire the at least one fire suppression container.

The firing means may further include an aiming means connected with the firing pipe to adjust an aiming direction of the firing pipe, a camera provided on an outer circumference of the firing pipe to capture an image of a view in front of the firing pipe in the aiming direction, and a monitor provided in a cockpit of the body to display the captured image.

The firefighting aircraft may further comprise a water tank including a plurality of discharge pipes provided on a lower outer circumference of the body and a plurality of electronic-controlled valves each of which is connected with a respective one of the discharge pipes. A water feeding pipe may be provided on a front portion of the body and be connected with the water tank. The water tank may be configured to receive water from another aircraft through the water feeding pipe while the firefighting aircraft is flying.

The air feeder may be connected with the water tank to supply a high-pressure of air to an inside of the water tank.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a side view illustrating a firefighting aircraft according to an embodiment;

FIG. 2 is a side cross-sectional view illustrating a fire suppression container of a firefighting aircraft, according to an embodiment; and

FIG. 3 is a side cross-sectional view illustrating a firing means of a firefighting aircraft according to an embodiment.

### DETAILED DESCRIPTION OF EXEMPLARY EMBODIMENTS

Hereinafter, embodiments of the disclosure are described with reference to the accompanying drawings. The same reference numbers or characters may be used to denote the same or substantially the same elements throughout the drawings and the specification. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

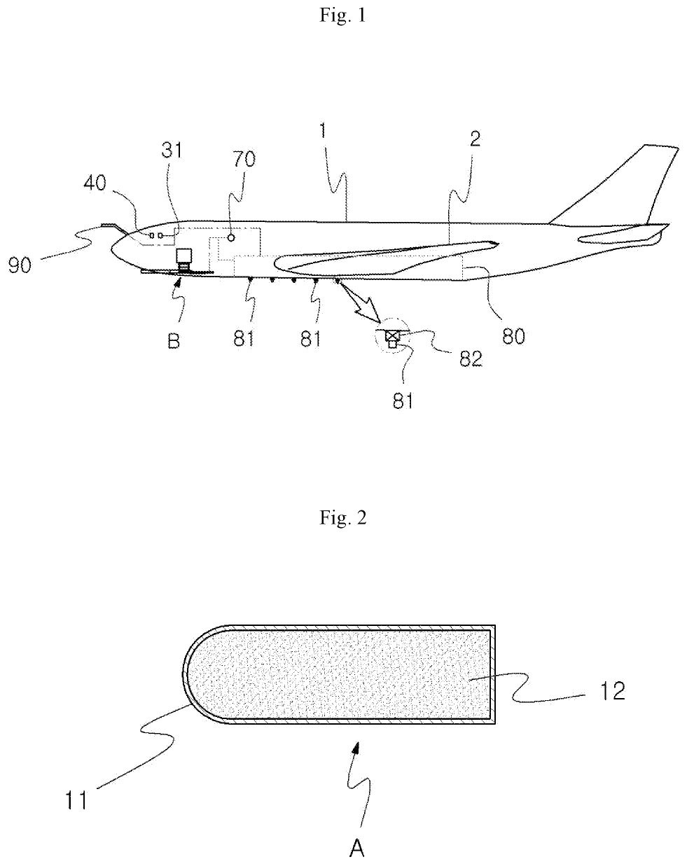

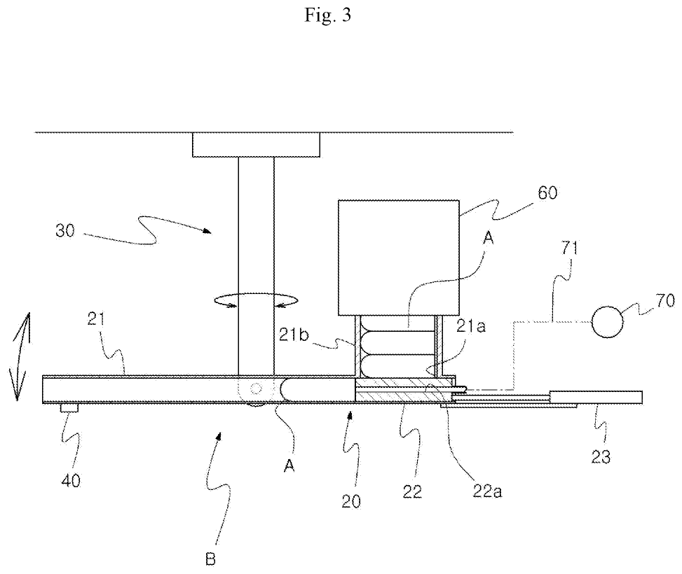

FIG. 1 is a side view illustrating a firefighting aircraft according to an embodiment. FIG. 2 is a side cross-sectional view illustrating a fire suppression container of a firefighting aircraft. FIG. 3 is a side cross-sectional view illustrating a firing means of a firefighting aircraft according to an embodiment. Referring to FIGS. 1 to 3, the firefighting aircraft may include a body 1 and wings 2. A pilot may sit on a seat provided in the body 1 to operate the controls of the firefighting aircraft.

According to an embodiment, the firefighting aircraft may further include a firing means B (e.g., a firing structure configured to fire bullet structures for fire suppression, such as, e.g., fire suppression containers A described below) provided on the body 1 to fire a fire suppression container A, a water tank 80 provided in the body 1 and having a plurality of discharge pipes 81 formed in a lower portion thereof, and a water feeding pipe 90 provided at a front side of the body 1 and connected with the water tank 80. The firing means B may be a launcher for fire suppression containers A.

Specifically, the fire suppression container A may be shaped as a bullet or missile. The fire suppression container A may have a casing 11 which is filled with a fire extinguishing material 12 as shown in FIG. 2.

The casing 11 may be formed of rigid plastic which may be broken, destroyed, or demolished by impacts and be shaped as a cylinder extending in the lengthwise direction thereof.

The first extinguishing material 12 may include at least one of a fire extinguishing liquid, a fire extinguishing powder, or a fire extinguishing foam.

If the fire suppression container A is fired to the fire site by the firing means B, the fire suppression container A may hit the ground or other objects, so that the casing 11 may be destroyed, allowing the first extinguishing material 12 stored in the casing 11 to fly and spread around and hence suppressing the fire.

The firing means B includes a firing pipe 20 having an open front end and oriented to an outside of the body 1, an aiming means 30 (e.g., an aimer or a direction adjuster or controller) connected with the firing pipe 20 to adjust the aiming direction of the firing pipe 20, a camera 40 provided on an outer circumference of the firing pipe 20 to capture an image of the view in front of the firing pipe 20 in the aiming direction, and a monitor 50 provided in a cockpit of the body 1 to display the captured image, a feeder 60 connected to a rear end of the firing pipe 20 to supply the at least one fire suppression container A to the inside of the firing pipe 20, and an air feeder 70 configured to supply a high-pressure of air to the inside of the firing pipe 20 to fire the at least one fire suppression container A.

The firing pipe 20 may be shaped as a pipe with openings at the front and rear tips thereof. The firing pipe 20 may be positioned on a front lower portion of the body 1 and extend to the outside of the body 1. The firing pipe 20 may include a pipe body 21 at a rear end thereof. The pipe body 21 may include an opening 21a through which the fire suppression containers A may be inserted. A sealing block 22 which may be slid back and forth by a driver 23 may be coupled to a rear end of the pipe body 21. As the sealing block 22 is slid or moved back and forth by the driver 23, the opening 21a of the pipe body 21 may be closed or sealed off.

The pipe body 21 may be formed of rigid or very hard metal. A guide pipe 21b may be provided in the opening 21a and the guide pipe 21b may extend upwards.

The driver 23 may be extended to the front or rear direction of the pipe body 21, and both ends of the driver 23 may be connected to the pipe body 21 and the sealing block 22. The driver 23 may be, or include, an air cylinder that allows the sealing block 22 to move back and forth as extended or contracted.

The sealing block 22 may be a cylindrical block that extends in the front and rear direction of the pipe body 21. A packing may be formed along the outer circumference of the sealing block 22. The sealing block 22 may be moved back and forth at the rear end of the firing pipe 20 to air-tightly seal the rear end of the firing pipe 20. When the sealing block 22 is moved back by the driver 23, the opening 21a may be open and, when the sealing block 22 is moved forth by the driver 23, the fire suppression container supplied to the inside of the pipe body 21 through the opening 21a may be pushed forwards while closing or sealing off the opening 21a.

An air feeding hole 22a may be formed through the center of the sealing block 22 along the front and back direction.

The aiming means 30 may be connected with an input means 31 (e.g., an input device or a controller) provided in the cockpit. When the pilot controls the input means 31, the aiming means 30 may control or adjust the aiming direction of the firing pipe 20 to the upper, lower, right, or left direction.

The aiming means 30 may adopt, or include, a known aiming means and thus no detailed description thereof is given.

The camera 40 is provided on a front portion of the firing pipe 20 to be oriented ahead or forwards.

The monitor 50 may be configured to display, in real-time, the image or video captured by the camera 40.

The feeder 60 may be connected with the guide pipe 21b and may align the plurality of fire suppression containers A and sequentially supply them to the inside of the guide pipe 21b.

The air feeder 70 may be, or include, an air compressor connected to the air feeding hole 22a through an air feeding pipe 71.

Thus, if the sealing block 22 is moved back by the driver 23 to open the opening 21a, and the fire suppression containers A are supplied by the feeder 60, then the fire suppression containers A may be inserted into the inside of the pipe body 21. If the sealing block 22 is moved forth or advanced by the driver 23, then the fire suppression container A may be pushed forwards while the sealing block 22 air-tightly seals off the opening 21a.

If a high-pressure of air is supplied through the air feeding hole 22a by the air feeder 70, the air may be supplied to the inside of the rear end of the firing pipe 20, pressurizing and firing the fire suppression container A from the firing pipe 20.

The pilot may control the input means 31 based on the image displayed on the monitor 50, so that the firing pipe 20 may aim at the fire and may identify, through the monitor 50, whether the fire suppression container A has been fired precisely at the fire.

The water tank 80 may detachably be coupled to a lower side of the body 1. The water tank 80 may contain a great quantity of water. The air feeder 70 may be connected to the water tank 80 to supply a high pressure of air to the inside of the water tank 80. The water stored in the water tank 80 may be pressurized by a high pressure of air supplied by the air feeder 70.

Each discharge pipe 81 has a valve 82, e.g., an electronically controlled valve, whose opening and closing is controlled by the input means 31.

The water feeding pipe 90 may be in substantially the same as what is used for aerial fueling and may extend upwards and forwards from the front portion of the body 1.

If the pilot controls the input means 31 to open the electronic-controlled valves 82 while the firefighting aircraft is flying over the fire, water contained in the water tank 80 may be dropped through the discharge pipes 81 to suppress the fire.

After the water in the water tank 80 is used up, the firefighting aircraft may receive water from an aerial tanker (e.g., an aircraft for supplying water to the firefighting aircraft) through the water feeding pipe 90 to refill the water tank 80 during flight.

To that end, the aerial tanker may have a huge water tank 80 and a feeding pipe extending from the water tank 80 at a rear side thereof. While the firefighting aircraft is flying behind the aerial tanker, the feeding pipe of the aerial tanker may be connected to the water feeding pipe 90 of the firefighting aircraft so that the water contained in the aerial tanker may be transferred to the water tank 80 of the firefighting aircraft.

How to transfer water from the aerial tanker to the firefighting aircraft may be substantially the same as what is performed for typical or known aerial fueling, and no detailed description thereof is presented below.

Thus, the firefighting aircraft may fire the fire suppression containers A precisely at the fire by way of the firing means B, thus suppressing the fire.

The plurality of fire suppression containers A may be continuously fired and the fire may be effectively suppressed.

When the firefighting aircraft runs out of water, the firefighting aircraft need not return for refilling and, instead, may be fed and refilled with water from another aircraft (e.g., the above-described aerial tanker) while keeping on flying.

This way leads to more efficiency in fire suppression.

Although in the above embodiments, the fire suppression containers A are fired using air pressure, embodiments of the disclosure are not limited thereto. For example, the firing means B may be configured as a mere pipe, and each fire suppression container A may be configured to have its own propulsion system as does a missile or rocket.

While the disclosure has been shown and described with reference to exemplary embodiments thereof, it will be apparent to those of ordinary skill in the art that various changes in form and detail may be made thereto without departing from the spirit and scope of the disclosure as defined by the following claims.

What is claimed is:

1. A firefighting aircraft with a body and wings, the firefighting aircraft comprising a firing means configured to fire at least one fire suppression container provided in the body, the at least one fire suppression container having a casing filled with a fire extinguishing material and formed of a material destroyed by an impact, and wherein the first extinguishing material includes at least one of a fire extinguishing liquid, a fire extinguishing powder, or a fire extinguishing foam.

2. The firefighting aircraft of claim 1, wherein the firing means includes a firing pipe having an open front end and oriented to an outside of the body, a feeder connected to a rear end of the firing pipe to supply the at least one fire suppression container to an inside of the firing pipe, and an air feeder configured to supply a high-pressure of air to the inside of the firing pipe to fire the at least one fire suppression container.

3. The firefighting aircraft of claim 2, wherein the firing means further includes an aiming means connected with the firing pipe to adjust an aiming direction of the firing pipe, a camera provided on an outer circumference of the firing pipe to capture an image of a view in front of the firing pipe in the aiming direction, and a monitor provided in a cockpit of the body to display the captured image.

4. The firefighting aircraft of claim 3, further comprising a water tank including a plurality of discharge pipes provided on a lower outer circumference of the body and a plurality of electronic-controlled valves each of which is connected with a respective one of the discharge pipes, wherein a water feeding pipe is provided on a front portion of the body and is connected with the water tank, and wherein the water tank is configured to receive water from another aircraft through the water feeding pipe while the firefighting aircraft is flying.

5. The firefighting aircraft of claim 4, wherein the air feeder is connected with the water tank to supply a high-pressure of air to an inside of the water tank.
